(19) United States
(12) Patent Application Publication
(10) Pub. No.: US 2023/0421013 A1
(43) Pub. Date: Dec. 28, 2023

(54) MOTOR ASSEMBLY

(71) Applicant: Delta Electronics, Inc., Taoyuan City (TW)

(72) Inventors: Chun-Nan Wu, Taoyuan City (TW); Yang-Hsin Lee, Taoyuan City (TW)

(21) Appl. No.: 17/895,456

(22) Filed: Aug. 25, 2022

(30) Foreign Application Priority Data
Mar. 25, 2022 (CN) 202210300811.8

(51) Int. Cl. H02K 5/10

(52) U.S. Cl. CPC H02K 5/10

(57) ABSTRACT

A motor assembly is provided. The rotor includes a hub and a first hollow portion. The first hollow portion is concavely formed from a surface of the hub. A first end of the winding component is disposed in the first hollow portion. The protection component includes an inner ring portion, an outer ring portion and a base. The inner ring portion includes a second hollow portion and a first concave. The fixing portion is penetrated through the second hollow portion and in the first hollow portion. The first concave is concavely formed on one side of the inner ring portion. The outer ring portion includes a second concave. The base is connected with the inner ring portion and the outer ring portion. A second end of the winding component is disposed in the first concave. The bottom portion of the casing is partially received within the second concave.

### CROSS-REFERENCE TO RELATED APPLICATION

This application claims priority to China Patent Application No. 202210300811.8 filed on Mar. 25, 2022, the entire contents of which are incorporated herein by reference for all purposes.

### FIELD OF THE INVENTION

The present invention relates to a motor assembly, and more particularly to a motor assembly having waterproof and dustproof functions.

### BACKGROUND OF THE INVENTION

Generally, a motor assembly has a circuit board disposed on one side of the motor assembly for transmitting the electric power. Usually, the following two methods are utilized on the circuit board of the conventional motor assembly for achieving the waterproof and dustproof functions. In the first method, the circuit board in the motor assembly and the electronic element on the circuit board are soaked on a protection liquor. Then, the circuit board and the electronic element on the circuit board are taken out and dried, so that a solidified protection layer is formed to cover the surface of the circuit board and the electronic element on the circuit board. Consequently, the waterproof and dustproof effects for the circuit board and the electronic element on the circuit board are achieved through the solidified protection layer.

In the second method, the whole motor assembly is disposed in the vapor deposition equipment. The motor assembly disposed in the vapor deposition equipment is subjected to an evaporation process, a decomposition process and a deposition process in sequence. A protection layer is formed on the entire surface of the motor assembly, so as to achieve the waterproof and dustproof effects for the motor assembly. Moreover, the waterproof and dustproof functions for the circuit board in the motor assembly are achieved at the same time. However, the above two methods need to take additional processes and time, so that the conventional motor assembly has the disadvantages of long producing time and high cost.

Therefore, there is a need of providing a motor assembly to obviate the drawbacks encountered from the prior arts.

### SUMMARY OF THE INVENTION

The present disclosure provides a motor assembly having the advantages of waterproofing and dustproofing.

In accordance with an aspect of the present disclosure, there is provided a motor assembly. The motor assembly includes a frame, a rotor, a winding component, a circuit board and a protection component. The frame includes a casing and a fixing portion. The casing includes a bottom portion. The fixing portion is disposed on the bottom portion. The rotor includes a hub, a first hollow portion and a plurality of blades. The hub includes a top surface and a bottom surface opposite to each other. The first hollow portion is concavely formed from the bottom surface of the hub toward the top surface. The plurality of blades are disposed around the hub. The winding component includes a first end and a second end. The first end of the winding component is disposed in the first hollow portion of the rotor. The protection component is disposed between the winding component and the bottom portion of the casing and includes an inner ring portion, an outer ring portion and a base. The inner ring portion includes a second hollow portion and a first concave. The second hollow portion is disposed in a center of the inner ring portion. The fixing portion is penetrated through the second hollow portion and in the first hollow portion. The first concave is concavely formed on one side of the inner ring portion facing the hub. The outer ring portion includes a second concave. The second concave is concavely formed on one side of the outer ring portion back to the hub. The base is connected with the inner ring portion and the outer ring portion. The base is located between the circuit board and the hub. The second end of the winding component is disposed in the first concave. The bottom portion of the casing toward the hub is at least partially received within the second concave.

In accordance with another aspect of the present disclosure, there is provided a motor assembly. The motor assembly includes a frame, a rotor, a winding component, a circuit board and a protection component. The frame includes a casing and a fixing portion. The casing includes a bottom portion. The fixing portion is disposed within the casing and fixed on the bottom portion. The rotor includes a hub, a first hollow portion and a plurality of blades. The hub includes a top surface and a bottom surface opposite to each other. The first hollow portion is concavely formed from the bottom surface of the hub toward the top surface. The plurality of blades are disposed around the hub. The winding component includes a first end and a second end. The first end of the winding component is disposed in the first hollow portion of the rotor. The protection component is disposed between the winding component and the bottom portion of the casing and includes an inner ring portion, an outer ring portion and a base. The inner ring portion includes a second hollow portion and a first concave. The second hollow portion is disposed in a center of the inner ring portion. The fixing portion is penetrated through the second hollow portion and in the first hollow portion. The first concave is concavely formed on one side of the inner ring portion facing the hub. The base is connected with the inner ring portion and the outer ring portion. The base is located between the circuit board and the hub. The second end of the winding component is disposed in the first concave. The bottom portion of the casing toward the hub is at least partially received within the second concave.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating a motor assembly according to a first embodiment of the present disclosure;

FIG. 2 is a schematic exploded view illustrating the motor assembly of FIG. 1;

FIG. 3 is a schematic view illustrating a protection component of the motor assembly of FIG. 1 taken along another viewpoint;

FIG. 4 is a schematic view illustrating the protection component and a circuit board of the motor assembly of FIG. 1;

FIG. 5 is a schematic cross-sectional view illustrating the motor assembly of FIG. 1;

FIG. 6 is a portion of schematic cross-sectional view illustrating the protection component of the motor assembly of FIG. 5;

FIG. 7 is a schematic view illustrating a motor assembly according to a second embodiment of the present disclosure;

FIG. 8 is a portion of schematic cross-sectional view illustrating the protection component of the motor assembly of FIG. 7.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. When an element is referred to as being “connected,” or “coupled,” to another element, it can be directly connected or coupled to the other element or intervening elements may be present. Although the wide numerical ranges and parameters of the present disclosure are approximations, numerical values are set forth in the specific examples as precisely as possible. In addition, although the “first,” “second,” “third,” and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments. Besides, “and/or” and the like may be used herein for including any or all combinations of one or more of the associated listed items. Alternatively, the word “about” means within an acceptable standard error of ordinary skill in the art-recognized average. In addition to the operation/working examples, or unless otherwise specifically stated otherwise, in all cases, all of the numerical ranges, amounts, values and percentages, such as the number for the herein disclosed materials, time duration, temperature, operating conditions, the ratio of the amount, and the like, should be understood as the word “about” decorator. Accordingly, unless otherwise indicated, the numerical parameters of the present invention and scope of the appended patent proposed is to follow changes in the desired approximations. At least, the number of significant digits for each numerical parameter should at least be reported and explained by conventional rounding technique is applied. Herein, it can be expressed as a range between from one endpoint to the other or both endpoints. Unless otherwise specified, all ranges disclosed herein are inclusive.

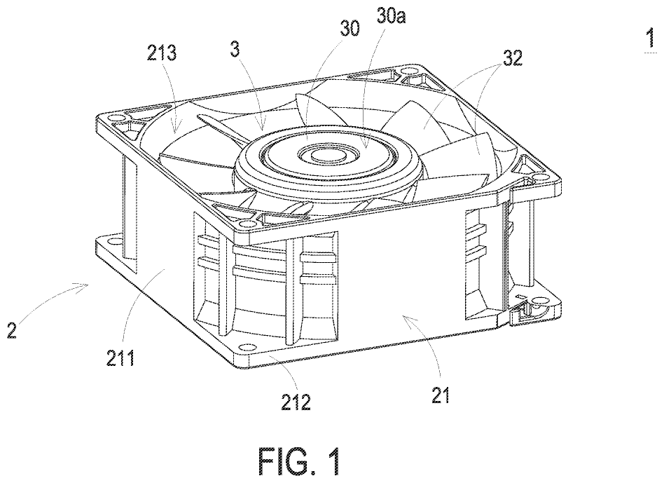

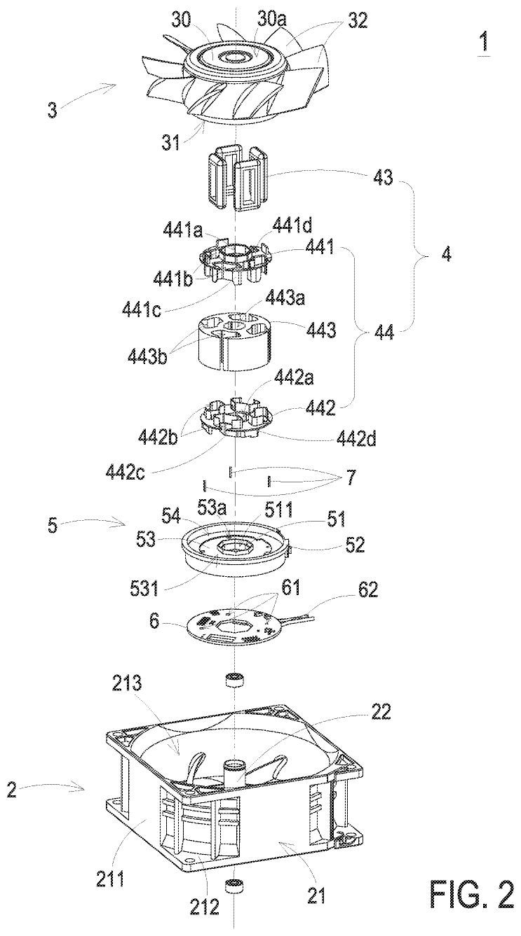

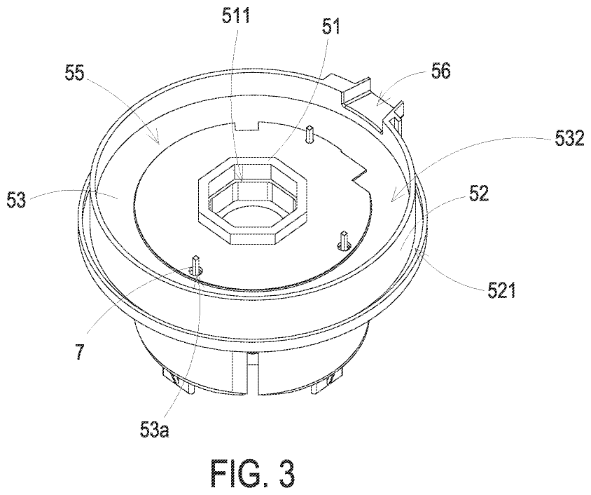

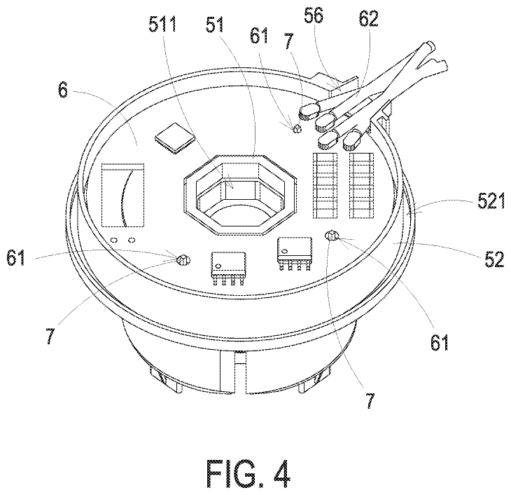

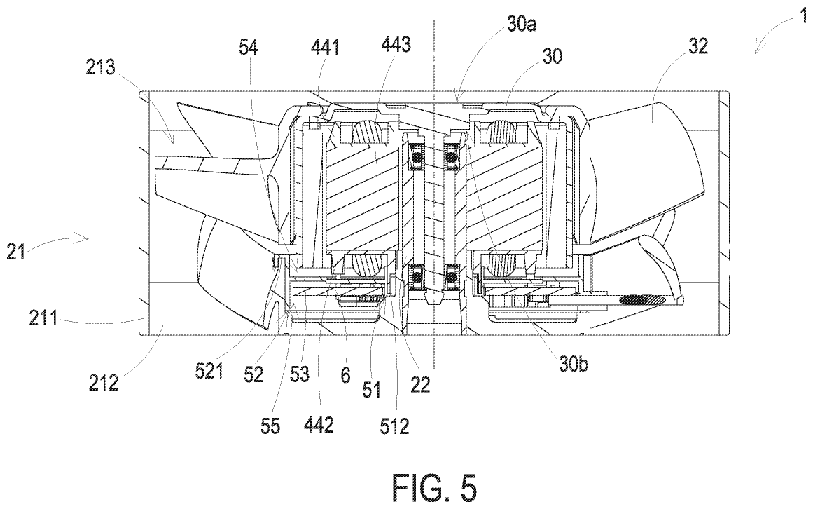

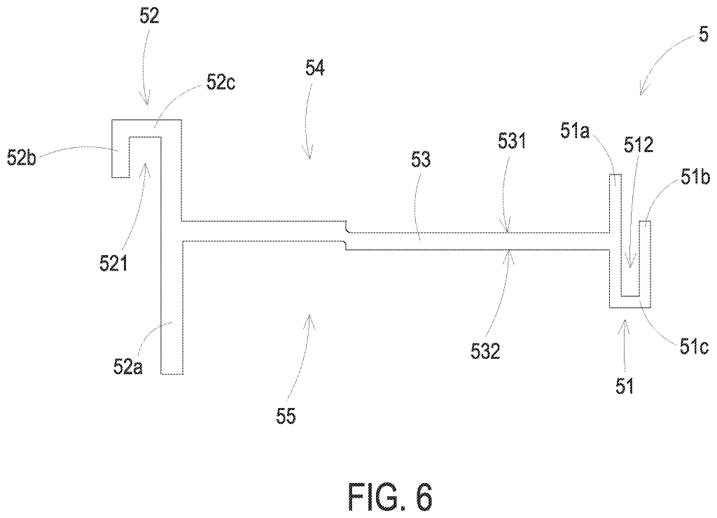

FIG. 1 is a schematic view illustrating a motor assembly according to a first embodiment of the present disclosure. FIG. 2 is a schematic exploded view illustrating the motor assembly of FIG. 1. FIG. 3 is a schematic view illustrating a protection component of the motor assembly of FIG. 1 taken along another viewpoint. FIG. 4 is a schematic view illustrating the protection component and a circuit board of the motor assembly of FIG. 1. FIG. 5 is a schematic cross-sectional view illustrating the motor assembly of FIG. 1. FIG. 6 is a portion of schematic cross-sectional view illustrating the protection component of the motor assembly of FIG. 5. As shown in FIG. 2, the motor assembly 1 includes a frame 2, a rotor 3, a winding component 4, a protection component 5 and a circuit board 6.

The frame 2 includes a casing 21 and a fixing portion 22. The casing 21 includes a plurality of lateral walls 211, a bottom portion 212 and a frame accommodation space 213. The plurality of lateral walls 211 are disposed around the bottom portion 212. The frame accommodation space 213 is collaboratively defined by the plurality of lateral walls 211 and the bottom portion 212. The frame accommodation space 213 includes an opening facing away the bottom portion 212 of the casing 21. The opening of the frame accommodation space 213 and the bottom portion 212 of the casing 21 are located in the two opposite sides of the frame 2, respectively. The fixing portion 22 is disposed within the casing 21 and fixed on the bottom portion 212. Moreover, the fixing portion 22 is extended from the bottom portion 212 of the casing 21 toward the opening of the frame accommodation space 213 and located in the frame accommodation space 213. The rotor 3 is disposed within the casing 21 of the frame 2 and includes a hub 30, a first hollow portion 31 and a plurality of blades 32. As shown in FIG. 5, the hub 30 includes a top surface 30a and a bottom surface 30b. The top surface 30a and the bottom surface 30b of the hub 30 are opposite to each other. The bottom surface 30b of the hub 30 is located between the top surface 30a of the hub 30 and the bottom portion 212 of the casing 21 of the frame 2. As shown in FIG. 1, the top surface 30a of the hub 30 of the rotor 3 and the bottom portion 212 of the casing 21 of the frame 2 are located in the two opposite sides of the motor assembly 1, respectively. The first hollow portion 31 is concavely formed from the bottom surface 30b of the hub 30 toward the top surface 30a of the hub 30 and located in the center of the rotor 3. The first hollow portion 31 includes an opening facing toward the bottom portion 212 of the casing 21. The plurality of blades 32 are disposed around the hub 30 equidistantly.

In the embodiment, the winding component 4 includes a first end and a second end opposite to each other. The first end of the winding component 4 is disposed in the first hollow portion 31 of the rotor 3. In this embodiment, the winding component 4 further includes a plurality of winding layers 43 and a stator 44. The plurality of winding layers 43 is spatially corresponding in position to the first hollow portion 31 and disposed in the first hollow portion 31. Each one of the plurality of winding layers 43 is perpendicular to the top surface 30a of the hub 30 of the rotor 3. In this embodiment, the number of the plurality of winding layers 43 is four.

The plurality of winding layers 43 are disposed on the stator 44. The stator 44 and the plurality of winding layers 43 are spatially corresponding in position to the first hollow portion 31 and disposed in the first hollow portion 31 of the rotor 3. The stator 44 includes a first holder 441, a second holder 442 and a core 443. As shown in FIG. 2, the first holder 441 and the second holder 442 are disposed in the two opposite sides of the stator 44, respectively. The first holder 441 further includes a first holder hollow portion 441a, a plurality of first holder holes 441b, a plurality of first holder walls 441c and a first holder main body 441d. The first holder hollow portion 441a is located in the center of the first holder 441 and runs through the first holder main body 441d of the first holder 441. The first holder hollow portion 441a is spatially corresponding in position to the fixing portion 22 of the frame 2. The plurality of first holder holes 441b are disposed around the first holder hollow portion 441a and run through the first holder main body 441d of the first holder 441. The number of the plurality of first holder holes 441b is corresponding to the number of the plurality of winding layers 43. As shown in FIG. 2, the number of the plurality of first holder holes 441b and the number of the plurality of winding layers 43 are four, respectively. Preferably but not exclusively, the plurality of first holder holes 441b are spatially corresponding in position to the plurality of winding layers 43, respectively. The plurality of first holder walls 441c are extended from the first holder main body 441d toward the second holder 442 and spatially corresponding in position to the plurality of first holder holes 441b, respectively. Preferably but not exclusively, each one of the plurality of first holder walls 441c is disposed around the corresponding first holder hole 441b, so that the space surrounded by each one of the plurality of first holder walls 441c is in communication with the corresponding first holder hole 441b.

The second holder 442 further includes a second holder hollow portion 442a, a plurality of second holder holes 442b, a plurality of second holder walls 442c and a second holder main body 442d. The second holder hollow portion 442a is located in the center of the second holder 442 and runs through the second holder main body 442d of the second holder 442. The second holder hollow portion 442a is spatially corresponding in position to the fixing portion 22 of the frame 2. The plurality of second holder holes 442b are disposed around the second holder hollow portion 442a and run through the second holder main body 442d of the second holder 442. The plurality of second holder holes 442b are spatially corresponding in position to the plurality of first holder holes 441b, respectively. The number of the plurality of second holder holes 442b is corresponding to the number of the plurality of winding layers 43. As shown in FIG. 2, the number of the plurality of second holder holes 442b and the number of the plurality of winding layers 43 are four, respectively. The plurality of second holder walls 442c are extended from the second holder main body 442d toward the first holder 441 and spatially corresponding in position to the plurality of second holder holes 442b, respectively. Each one of the plurality of second holder walls 442c is disposed around the corresponding second holder hole 442b, so that the space surrounded by each one of the plurality of second holder walls 442c is in communication with the corresponding second holder hole 442b. The plurality of winding layers 43, the plurality of second holder holes 442b and the plurality of first holder holes 441b are spatially corresponding in position to each other. Preferably but not exclusively, each one of the plurality of winding layers 43 is disposed and penetrated through the corresponding second holder hole 442b and the corresponding first holder hole 441b.

The core 443 is made of a silicon steel plate, but not limited thereto. The core 443 is located between the first holder 441 and the second holder 442. The core 443 further includes a core hollow portion 443a and a plurality of core penetrating holes 443b. The core hollow portion 443a is located in the center of the core 443 and runs through the core 443. The core hollow portion 443a of the core 443 is spatially corresponding in position to the fixing portion 22 of the frame 2. The plurality of core penetrating holes 443b are disposed around the core hollow portion 443a and run through the core 443. The number of the plurality of core penetrating holes 443b is corresponding to the number of the second holder holes 442b and the number of the first holder holes 441b, respectively. As shown in FIG. 2, the number of the plurality of core penetrating holes 443b, the number of the second holder holes 442b and the number of the first holder holes 441b are four, respectively. The plurality of core penetrating holes 443b, the plurality of first holder walls 441c and the plurality of second holder walls 442c are spatially corresponding in position to each other. Each one of the plurality of first holder walls 441c and the corresponding second holder wall 442c are at least partially received within the corresponding core penetrating hole 443b, so that the first holder hole 441b and the second holder hole 442b are located in the corresponding core penetrating hole 443b, and the first holder 441 and the second holder 442 are engaged in the core 443. The plurality of winding layers 43, the plurality of first holder holes 441b and the plurality of second holder holes 442b are spatially corresponding in position to each other. Each one of the plurality of winding layers 43 is penetrated through the corresponding first holder hole 441b and the corresponding second holder hole 442b, so that each one of the plurality of winding layers 43 is disposed in the corresponding core penetrating hole 443b. In this embodiment, the first holder 411 has an end facing away from the second holder 412 and configured to form the first end of the winding component 4. The second holder 412 has an end facing away from the first holder 411 and configured to form the second end of the winding component 4. Namely, the first end of the winding component 4 and the second end of the winding component 4 are two opposite ends.

The protection component 5 is disposed between the winding component 4 and the bottom portion 212 of the casing 21 and includes an inner ring portion 51, an outer ring portion 52 and a base 53. The inner ring portion 51 and the base 53 are connected to each other. The inner ring portion 51 includes a second hollow portion 511, a first concave 512, a first inner ring wall 51a, a second inner ring wall 51b and an inner ring bottom wall 51c. As shown in FIG. 2, the second hollow portion 511 is located in the center of the inner ring portion 51 and runs through the inner ring portion 51. The second hollow portion 511, the second holder hollow portion 442a, the core hollow portion 443a of the core 443 and the first holder hollow portion 441a are spatially corresponding in position to the fixing portion 22 of the frame 2, so that the fixing portion 22 of the frame 2 is penetrated through the second hollow portion 511 of the inner ring portion 51, the second holder hollow portion 442a, the core hollow portion 443a of the core 443 and the first holder hollow portion 441a in sequence. Consequently, the fixing portion 22 of the frame 2 is connected to a rotating shaft of the rotor 3 through a bearing, and disposed in the first hollow portion 31 of the rotor 3, so that the protection component 5, the core 443, the first holder 441, the second holder 442 and the rotor 3 are disposed on the frame 2.

The detail structure of the protection component 5 is shown in FIG. 6. FIG. 6 only shows a portion of the protection component 5 of FIG. located in the left side of the fixing portion 22. It is clear that the other portion of the protection component 5 of FIG. 5 located in the right side of the fixing portion 22 is similar and symmetric to the protection component of FIG. 5 located in the left side of the fixing portion 22, and is not redundantly described hereinafter. As shown in FIG. 6, the first inner ring wall 51a is perpendicular to the base 53 and connected with the base 53. In the embodiment, the first inner ring wall 51a includes a first end and a second end opposite to each other. The first end of the first inner ring wall 51a is protruded from the upper surface 531 of the base 53. The second end of the first inner ring wall 51a is protruded from the lower surface 532 of the base 53. The first inner ring wall 51a is disposed between the second inner ring wall 51b and the base 53. The second inner ring wall 51b is parallel to the first inner ring wall 51a, and the second inner ring wall 51b includes a first end and a second end opposite to each other. In this embodiment, the length of the second inner ring wall 51b is less than the length of the first inner ring wall 51a. The inner ring bottom wall 51c is connected between the second end of the first inner ring wall 51a and the second end of the second inner ring wall 51b. The inner ring bottom wall 51c is perpendicular to the first inner ring wall 51a and the second inner ring wall 51b, respectively. The distance formed between the first end of the first inner ring 51a and the inner ring bottom wall 51c is greater than the distance formed between the first end of the second inner ring wall 51b and the inner ring bottom wall 51c. The first concave 512 of the inner ring portion 51 is collaboratively defined by the first inner ring wall 51a, the second inner ring wall 51b and the inner ring bottom wall 51c. In other words, the first concave 512 of the inner ring portion 51 is concavely formed on one side of the inner ring portion 51 facing the hub 30 of the rotor 3 so as to form an opening, and the opening of the first concave 512 faces toward the top surface 30a of the hub 30 of the rotor 3. The second holder 442 includes a lower end at least partially received within the first concave 512, i.e., the second end of the winding component 4 facing away from the first holder 441 is at least partially received within the first concave 512.

The outer ring portion 52 is disposed around the inner ring potion 51 and includes a first outer ring wall 52a, a second outer ring wall 52b, an outer ring bottom wall 52c and a second concave 521. The first outer ring wall 52a is perpendicular to the base 53 and connected with the base 53. In the embodiment, the first outer ring wall 52a includes a first end and a second end opposite to each other. The first end of the first outer ring wall 52a is protruded from the lower surface 532 of the base 53. The second end of the first outer ring wall 52a is protruded from the upper surface 531 of the base 53. The first outer ring wall 52a is disposed between the second outer ring wall 52b and the base 53. The second outer ring wall 52b is parallel to the first outer ring wall 52a, and includes a first end and a second end opposite to each other. In this embodiment, the length of the second outer ring wall 52b is less than the length of the first outer ring wall 52a. The outer ring bottom wall 52c is connected between the second end of the first outer ring wall 52a and the second end of the second outer ring wall 52b. The outer ring bottom wall 52c is perpendicular to the first outer ring wall 52a and the second outer ring wall 52b, respectively. The distance formed between the first end of the first outer ring wall 52a and the outer ring bottom wall 52c is greater than the distance formed between the first end of the second outer ring wall 52b and the outer ring bottom wall 52c. The second concave 521 of the outer ring portion 52 is collaboratively defined by the first outer ring wall 52a, the second outer ring wall 52b, the outer ring bottom wall 52c. Namely, the second concave 521 of the outer ring portion 52 is concavely formed on one side of the outer ring portion 52 back to the hub 30 of the rotor so as to form an opening, and the opening of the second concave 521 back to the rotor 3. Namely, the opening of the second concave 521 faces toward the bottom portion 212 of the casing 21. A portion of the casing 21 of the frame 2 extended from the bottom portion 212 of the casing 21 toward the top surface 30a of the hub 30 of the rotor 3 is at least partially received within the second concave 521, so that the protection component 5 is fixed on the frame 2.

Please refer to FIGS. 2 and 6. The base 53 are connected with the outer ring portion 52 and the inner ring portion 51 and located between the circuit board 6 and the hub 30 of the rotor 3. The base 53 includes a first accommodation space 54 and a second accommodation space 55. The first accommodation space 54 is disposed on the upper surface 531 of the base 53. The second accommodation space 55 is disposed on the lower surface 532 of the base 53. Namely, the first accommodation space 54 and the second accommodation space 55 are located in the two opposite sides of the base 53. The first accommodation space 54 is located between the first outer ring wall 52a of the outer ring portion 52 and the first inner ring wall 51a of the inner ring portion 51. A portion of the second holder 442 is at least partially received within the first accommodation space 54. The second accommodation space 55 is located between the outer ring portion 52 and the inner ring portion 51, and the circuit board 6 is at least partially received within the second accommodation space 55, as shown in FIGS. 4 and 5.

From above, the motor assembly 1 of the present disclosure includes the protection component 5. The outer ring portion 52 of the protection component 5 includes the second concave 521. The opening of the second concave 521 back to the hub 30 of the rotor 3. The inner ring portion 51 of the protection component 5 includes the first concave 512. The opening of the first concave 512 faces toward the top surface 30a of the hub 30 of the rotor 3. Namely, a zigzag design is collaboratively formed by the second concave 521 of the outer ring portion 52, the base 53 and the first concave 512 of the inner ring portion 51 so as to prevent water from entering into the interior of the motor assembly 1 and prevent water from invading the circuit board 6 located in the second accommodation space 55. The motor assembly 1 of the present disclosure has waterproof function. The conventional motor assembly has to take additional processes and time to have waterproof function. Comparing with the conventional waterproof casing, the process time and the cost of the motor assembly 1 of the present disclosure are reduced. In addition, the circuit board 6 is disposed in the protection component 5 so as to prevent dust from sticking on the circuit board 6 and prevent foreign materials from entering into the interior of the motor assembly 1 to scratch the circuit board 6. Consequently, the efficacy of the motor assembly 1 is enhanced.

Please refer to FIGS. 2, 3 and 4 again. In this embodiment, the motor assembly 1 further includes a plurality of pins 7. As shown in FIG. 2, the motor assembly 1 includes three pins 7. The base 53 of the protection component 5 further includes a plurality of first pin holes 53a. As shown in FIG. 2, the base 53 of the protection component 5 includes three first pin holes 53a. The circuit board 6 includes a plurality of second pins holes 61. When the circuit board 6 is disposed in the second accommodation space 55 of the protection component 5, as shown in FIG. 4, the plurality of second pin holes 61 are spatially corresponding in position to the plurality of first pin holes 53a. Each one of the plurality of pins 7 is penetrated through the corresponding second pin hole 61 and the corresponding first pin hole 53a. In some embodiments, the first pin hole 53a and the second pin hole 61 include an adhesive material, respectively. The first pin hole 53a and the second pin hole 61 are filled with the adhesive material, so that the pin 7 is fixed on the base 53 of the protection component 5 and the circuit board 6.

Please refer to FIGS. 2, 3 and 4 again. The circuit board 6 of the motor assembly 1 further includes a plurality of connection wires 62 for transmitting power or signal. The protection component 5 further includes a wire casing 56 disposed on the outer ring portion 52 for receiving the plurality of connection wires 62 of the circuit board 6. In some embodiments, the wire casing 56 includes adhesive material. The wire casing 56 is filled with the adhesive material for fixing the connection wire 62 on the protection component 5 so as to prevent water from entering into the interior of the motor assembly 1.

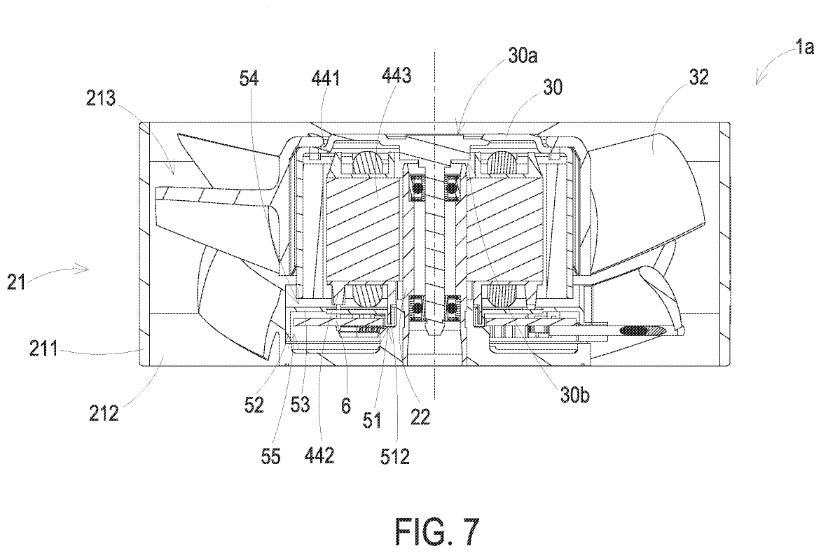

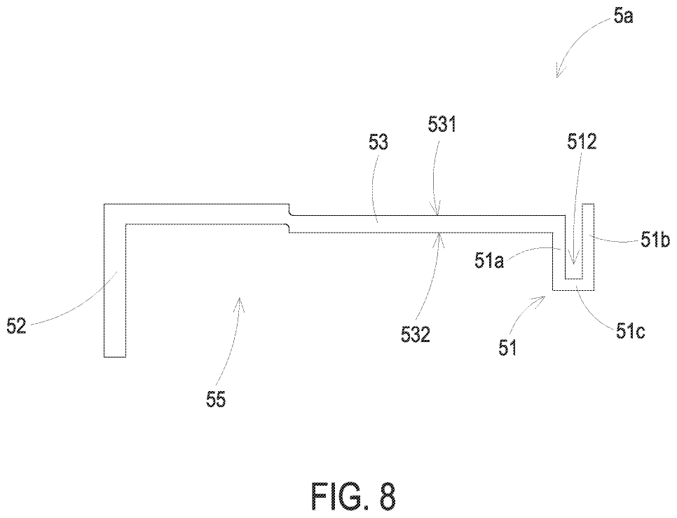

Please refer to FIGS. 7 and 8. FIG. 7 is a schematic view illustrating a motor assembly according to a second embodiment of the present disclosure. FIG. 8 is a portion of schematic cross-sectional view illustrating the protection component of the motor assembly of FIG. 7. The motor assembly 1a of this embodiment is similar to the motor assembly 1 of the first embodiment. Comparing with the motor assembly 1 of the first embodiment, the protection component 5a of the motor assembly 1a of this embodiment is different to the protection component 5 of the motor assembly 1 of the first embodiment. For simplifying the figure, FIG. 8 only shows a portion of the protection component 5a of FIG. 7 located in the left side of the fixing portion 22. It is clear that the other portion of the protection component 5a of FIG. 7 located in the right side of the fixing portion 22 is similar and symmetric to the protection component 5 of FIG. 5 located in the left side of the fixing portion 22, and is not redundantly described hereinafter. As shown in FIGS. 7 and 8, the inner ring portion 51 of the protection component 5a of this embodiment includes a second hollow portion 511, a first concave 512, a first inner ring wall 51a, a second inner ring wall 51b and an inner ring bottom wall 51c. The second hollow portion 511 of this embodiment is similar to the second hollow portion 511 of the protection component 5 of the motor assembly 1 of the first embodiment, and is not redundantly described hereinafter. The first inner ring wall 51a is perpendicular to the base 53 and connected with the base 53. The first inner ring wall 51a includes a first end and a second end opposite to each other. The first end of the first inner ring wall 51a and the upper surface 531 of the base 53 are coplanar with each other. The second end of the first inner ring wall 51a is protruded from the lower surface 532 of the base 53. The first inner ring wall 51a is disposed between the second inner ring wall 51b and the base 53. The second inner ring wall 51b is parallel to the first inner ring wall 51a and includes a first end and a second end opposite to each other. In this embodiment, the length of the second inner ring wall 51b is greater than the length of the first inner ring wall 51a. The inner ring bottom wall 51c is connected between the second end of the first inner ring wall 51a and the second end of the second inner ring wall 51b. The inner ring bottom wall 51c is perpendicular to the first inner ring wall 51a and the second inner ring wall 51b, respectively. The distance formed between the first end of the first inner ring wall 51a and the inner ring bottom wall 51c is less than the distance formed between the first end of the second inner ring wall 51b and the inner ring bottom wall 51c. The first concave 512 of the inner ring portion 51 is collaboratively defined by the first inner ring wall 51a, the second inner ring wall 51b and the inner ring bottom wall 51c. The first concave 512 includes an opening facing toward the top surface 30a of the hub 30 of the rotor 3. The second holder 442 includes a lower end at least partially received within the first concave 512. Namely, the second end of the winding component 4 facing away from the first holder 441 is at least partially received within the first concave 512. As shown in FIG. 8, the outer ring portion 52 of the protection component 5a of this embodiment is made of a single wall. The outer ring portion 52 is perpendicular to the base 53 and connected with the base 53. The outer ring portion 52 includes a first end and a second end opposite to each other. The first end of the outer ring portion 52 adjacent to the top surface 30 of the rotor 3 is coplanar with the upper surface 531 of the base 53, so that the protection component 5a of the motor assembly 1a of this embodiment only includes a single accommodation space 55, as shown in FIG. 8. The accommodation space 55 is located on the lower surface 532 of the base 53, and located between the outer ring portion 52 and the first inner ring wall 51a of the inner ring portion 51.

As mentioned above, the motor assembly of the present disclosure includes the protection component. The outer ring portion of the protection component includes the second concave. The opening of the second concave faces back to the hub of the rotor. The inner ring portion of the protection component includes the first concave. The opening of the first concave faces toward the top surface of the hub of the rotor. Namely, a zigzag design is collaboratively formed by the second concave of the outer ring portion, the base and the first concave of the inner ring portion so as to prevent water from entering into the interior of the motor assembly and prevent water from invading the circuit board located in the second accommodation space. The motor assembly of the present disclosure has waterproof function. The process time and the cost of the motor assembly of the present disclosure are reduced. In addition, the circuit board is disposed in the protection component so as to prevent dust from sticking on the circuit board and prevent foreign materials from entering into the interior of the motor assembly to scratch the circuit board. Consequently, the efficacy of the motor assembly is enhanced.

While the invention has been described in terms of what is presently considered to be the most practical and preferred embodiments, it is to be understood that the invention needs not be limited to the disclosed embodiment.

What is claimed is:

1. A motor assembly, comprising:
a frame comprising a casing and a fixing portion, wherein the casing comprises a bottom portion, the fixing portion is disposed on the bottom portion;
a rotor comprising a hub, a first hollow portion and a plurality of blades, wherein the hub comprises a top surface and a bottom surface opposite to each other, the first hollow portion is concavely formed from the bottom surface of the hub toward the top surface, and the plurality of blades are disposed around the hub;
a winding component comprising a first end and a second end, wherein the first end of the winding component is disposed in the first hollow portion of the rotor;
a circuit board; and
a protection component disposed between the winding component and the bottom portion of the casing and comprising an inner ring portion, an outer ring portion and a base, wherein the inner ring portion comprises a second hollow portion and a first concave, the second hollow portion is disposed in a center of the inner ring portion, the fixing portion is penetrated through the second hollow portion and in the first hollow portion, the first concave is concavely formed on one side of the inner ring portion facing the hub, the outer ring portion comprises a second concave, the second concave is concavely formed on one side of the outer ring portion back to the hub, the base is connected with the inner ring portion and the outer ring portion, and the base is located between the circuit board and the hub, the second end of the winding component is disposed in the first concave, and the bottom portion of the casing toward the hub is at least partially received within the second concave.

2. The motor assembly according to claim 1, wherein the inner ring portion comprises a first inner ring wall, a second inner ring wall and an inner ring bottom wall, wherein the first inner ring wall is connected with the base and comprises a first end and a second end opposite to each other, the first end of the first inner ring wall is protruded from an upper surface of the base, the second end of the first inner ring wall is protruded from a lower surface of the base, and the first inner ring wall is disposed between the second inner ring wall and the base, wherein the second inner ring wall comprises a first end and a second end opposite to each other, wherein the inner ring bottom wall is connected between the second end of the first inner ring wall and the second end of the second inner ring wall, wherein the first concave is collaboratively defined by the first inner ring wall, the second inner ring wall and the inner ring bottom wall.

3. The motor assembly according to claim 2, wherein a first length of the second inner ring wall is less than a second length of the first inner ring wall, and a first distance formed between the first end of the first inner ring wall and the inner ring bottom wall is greater than a second distance formed between the first end of the second inner ring wall and the inner ring bottom wall.

4. The motor assembly according to claim 1, wherein the outer ring portion comprises a first outer ring wall, a second outer ring wall and an outer ring bottom wall, wherein the first outer ring wall is connected with the base and comprises a first end and a second end opposite to each other, the first end of the first outer ring wall is protruded from a lower surface of the base, the second end of the first outer ring wall is protruded from an upper surface of the base, and the first outer ring wall is disposed between the second outer ring wall and the base, wherein the second outer ring wall comprises a first end and a second end opposite to each other, and the outer ring bottom wall is connected between the second end of the first outer ring wall and the second end of the second outer ring wall, wherein the second concave is collaboratively defined by the first outer ring wall, the second outer ring wall and the outer ring bottom wall.

5. The motor assembly according to claim 4, wherein a first length of the second outer ring wall is less than a second length of the first outer ring wall, and a first distance formed between the first end of the first outer ring wall and the outer ring bottom wall is greater than a second distance formed between the first end of the second outer ring wall and the outer ring bottom wall.

6. The motor assembly according to claim 1, wherein the winding component comprises a plurality of winding layers and a stator, the plurality of winding layers are disposed on the stator, the stator comprises a first holder, a second holder and a core, the first holder and the second holder are disposed in two opposite sides of the stator, and the first holder is adjacent to the top surface of the hub than the second holder.

7. The motor assembly according to claim 6, wherein the first holder comprises a first holder hollow portion, a plurality of first holder holes, a plurality of first holder walls and a first holder main body, and the first holder hollow portion is disposed in a center of the first holder and runs through the first holder main body, wherein the first holder hollow portion is spatially corresponding in position to the fixing portion, the plurality of first holder holes are disposed around the first holder hollow portion and run through the first holder main body, the plurality of first holder walls are extended from the first holder main body toward the second holder and spatially corresponding in position to the plurality of first holder holes, and each one of the plurality of first holder walls is disposed around corresponding one of the plurality of first holder holes.

8. The motor assembly according to claim 7, wherein the second holder comprises a second holder hollow portion, a plurality of second holder holes, a plurality of second holder walls and a second holder main body, the second holder hollow portion is disposed in a center of the second holder and runs through the second holder main body, wherein the second holder hollow portion is spatially corresponding in position to the fixing portion, the plurality of second holder holes are disposed around the second holder hollow portion and run through the second holder main body, the plurality of second holder walls are extended from the second holder main body toward the first holder and spatially corresponding in position to the plurality of second holder holes, and each one of the plurality of second holder walls is disposed around the corresponding one of the plurality of second holder holes.

9. The motor assembly according to claim 8, wherein the core is disposed between the first holder and the second holder, the core comprises a core hollow portion and a plurality of core penetrating holes, and the core hollow portion is disposed in a center of the core and runs through the core, wherein the core hollow portion is spatially corresponding in position to the fixing portion, the plurality of core penetrating holes, the plurality of first holder walls and the plurality of second holder walls are spatially corresponding in position to each other, and each one of the plurality of first holder walls and corresponding one of the plurality of second holder walls are received by corresponding one of the plurality of core penetrating holes, wherein the plurality of winding layers, the plurality of first holder holes and the plurality of second holder holes are spatially corresponding in position to each other, and each one of the plurality of winding layers is penetrated through the corresponding one of the plurality of first holder holes and the corresponding one of the plurality of second holder holes and disposed in the corresponding one of the plurality of core penetrating holes, wherein the fixing portion, the second holder hollow portion, the core hollow portion and the first holder hollow portion are spatially corresponding in position to each other, and the fixing portion is penetrated through the second holder hollow portion, the core hollow portion and the first holder hollow portion.

10. The motor assembly according to claim 1, wherein the base comprises a first accommodation space disposed on an upper surface thereof and a second accommodation space disposed on a lower surface thereof, wherein the first accommodation space and the second accommodation space are located between the outer ring portion and the inner ring portion, respectively, the second holder is partially received within the first accommodation space, and the circuit board is received within the second accommodation space.

11. The motor assembly according to claim 1, wherein the motor assembly comprises a plurality of pins, the base comprises a plurality of first pin holes, the circuit board comprises a plurality of second pin holes, the plurality of second pin holes are spatially corresponding in position to the plurality of first pin holes, and each one of the plurality of pins is penetrated through corresponding one of the plurality of second pin holes and corresponding one of the plurality of first pin holes.

12. The motor assembly according to claim 1, wherein the motor assembly comprises a plurality of connection wires, and the protection component comprises a wire casing disposed on the outer ring portion for receiving the plurality of connection wires.

13. A motor assembly, comprising:
a frame comprising a casing and a fixing portion, wherein the casing comprises a bottom portion, the fixing portion is disposed on the bottom portion;
a rotor comprising a hub, a first hollow portion and a plurality of blades, wherein the hub comprises a top surface and a bottom surface opposite to each other, the first hollow portion is concavely formed from the bottom surface of the hub toward the top surface, and the plurality of blades are disposed around the hub;
a winding component comprising a first end and a second end, wherein the first end of the winding component is disposed in the first hollow portion of the rotor;
a circuit board; and
a protection component disposed between the winding component and the bottom portion of the casing and comprising an inner ring portion, an outer ring portion and a base, wherein the inner ring portion comprises a second hollow portion and a first concave, the second hollow portion is disposed in a center of the inner ring portion, the fixing portion is penetrated through the second hollow portion and in the first hollow portion, the first concave is concavely formed on one side of the inner ring portion facing the hub, the base is connected with the inner ring portion and the outer ring portion, and the base is located between the circuit board and the hub, and the second end of the winding component is disposed in the first concave, and the bottom portion of the casing toward the hub is at least partially received within the second concave.

14. The motor assembly according to claim 13, wherein the inner ring portion comprises a first inner ring wall, a second inner ring wall and an inner ring bottom wall, wherein the first inner ring wall is connected with the base and comprises a first end and a second end opposite to each other, the first end of the first inner ring wall and an upper surface of the base are coplanar with each other, the second end of the first inner ring wall is protruded from a lower surface of the base, and the first inner ring wall is disposed between the second inner ring wall and the base, wherein the second inner ring wall comprises a first end and a second end opposite to each other, and the inner ring bottom wall is connected between the second end of the first inner ring wall and the second end of the second inner ring wall, wherein the first concave is collaboratively defined by the first inner ring wall, the second inner ring wall and the inner ring bottom wall.

15. The motor assembly according to claim 14, wherein a first length of the second inner ring wall is greater than a second length of the first inner ring wall, and a first distance formed between the first end of the first inner ring wall and the inner ring bottom wall is less than a second distance formed between the first end of the second inner ring wall and the inner ring bottom wall.

16. The motor assembly according to claim 13, wherein the base comprises an accommodation space disposed on a lower surface thereof, and the accommodation space is disposed between the outer ring portion and the inner ring portion for receiving the circuit board.
